(19) United States
(12) Patent Application Publication
(10) Pub. No.: US 2025/0286754 A1
(43) Pub. Date: Sep. 11, 2025

(54) WIRELESS LOCAL AREA NETWORK (WLAN) FAST LINK ADAPTATION

(71) Applicant: MaxLinear, Inc., Carlsbad, CA (US)

(72) Inventors: Rainer Strobel, München (DE); Sigurd Schelstraete, Menlo Park, CA (US); Avi Avraham Mansour, Givat-Shmuel (IL); Ziv Avital, Kadima (IL)

(73) Assignee: MaxLinear, Inc., Carlsbad, CA (US)

(21) Appl. No.: 19/075,737

(22) Filed: Mar. 10, 2025

Related U.S. Application Data
(60) Provisional application No. 63/563,208, filed on Mar. 8, 2024.

(51) Int. Cl. H04L 25/02; H04B 3/46; H04B 17/309; H04W 84/12; H04W 88/08

(52) U.S. Cl. CPC H04L 25/0224; H04B 3/46; H04B 17/346; H04W 84/12; H04W 88/08

(57) ABSTRACT

An access point (AP) may include a processing device. The processing device may identify, at the AP, one or more measurement inputs from one or more of a sounding packet or a data packet. The processing device may identify, at the AP, one or more link settings. The processing device may compute, at the AP, one or more predicted performance parameters based on the one or more measurement inputs and the one or more link settings.

### RELATED APPLICATION

This application claims the benefit of U.S. Provisional Application No. 63/563,208, filed Mar. 8, 2024, the disclosure of which is incorporated herein by reference in its entirety for all purposes.

The examples discussed in the present disclosure are related to wireless local area networks.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

An access point (AP) may include a processing device. The processing device may identify, at the AP, one or more measurement inputs from one or more of a sounding packet or a data packet. The processing device may identify, at the AP, one or more link settings. The processing device may compute, at the AP, one or more predicted performance parameters based on the one or more measurement inputs and the one or more link settings.

An AP may include a processing device. The processing device may receive, at the AP from a station (STA), a signal-to-noise ratio (SNR) margin. The processing device may compute, at the AP, a predicted SNR margin based on a performance estimation. The processing device may compute, at the AP, an SNR gap based on a difference between the predicted SNR margin and the SNR margin.

A station (STA) may include a processing device. The processing device may compute, at the STA, an SNR margin. The processing device may compute, at the STA, SNR margin feedback based on the SNR margin. The processing device may send, from the STA to an access point (AP), the SNR margin feedback.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example wireless local area network with two stations (STAs).

FIG. 2A illustrates an example predictive link adaptation flow diagram.

FIG. 2B illustrates an example predictive link adaptation flow diagram.

FIG. 3 illustrates an example graph for dependency between mutual information and coded bit error rate (BER) for the different low density parity check (LDPC) code rates of Wi-Fi® assuming no puncturing and shortening and the largest code size.

FIG. 4 illustrates an example graph for dependency between capacity and signal-to-noise ratio (SNR) for different quadrature amplitude modulation (QAM) constellations.

FIG. 5 illustrates an example flow diagram for transmitter-side SNR gap control with acknowledgments.

FIG. 6 illustrates an example flow diagram for transmitter-side SNR gap control with acknowledgments and SNR margin feedback.

FIG. 7 illustrates an example graph for dependency between capacity and SNR for WLAN QAM constellations.

FIG. 8 illustrates an example graph for dependency between generalized mutual information (GMI) in bits and bit error rate (BER) for different WLAN LDPC code rates.

FIG. 9A illustrates example graphs for coded BER vs. raw BER for 4-QAM with LDPC rate 3/4 (MCS2) and 16-QAM and LDPC rate 3/4 (MCS4).

FIG. 9B illustrates an example graph for SNR vs. raw BER for MCS2 and MCS4.

FIG. 10A illustrates example graphs for dependency between GMI and raw BER and coded BER for MCS2 and MCS4.

FIG. 10B illustrates example graphs for dependency between SNR and GMI for MCS 2 and MCS4.

FIG. 11 illustrates beamformed transmission with unequal modulation.

FIG. 12 illustrates a block diagram of an example system configured to perform WLAN fast link adaptation.

FIG. 13 illustrates an example process flow for WLAN fast link adaptation.

FIG. 14 illustrates an example process flow for WLAN fast link adaptation.

FIG. 15 illustrates an example process flow for WLAN fast link adaptation.

FIG. 16 illustrates a diagrammatic representation of a machine in the example form of a computing device within which a set of instructions, for causing the machine to perform any one or more of the methods discussed herein, may be executed.

### DESCRIPTION

Wireless local area network (WLAN) operates in an environment where the channel conditions may change continuously. Therefore, the transmission settings may be adapted for the packet by the link adaptation. In some transmission modes, e.g., non-beamformed point-to-point transmission, the receiver feedback available may be acknowledgements of the transmitted packets. The Minstrel algorithm may be used for link adaptation to adjust transmission settings with acknowledgements as the available feedback.

More recent WLAN standards may use beamforming, multi-user multiple input multiple output (MU-MIMO), and/or orthogonal frequency division multiple access (OFDMA) transmission. These modes may use channel estimation feedback from the receiver. MU-MIMO and OFDMA may allow simultaneous transmission from the access point (AP) to multiple stations (STAs).

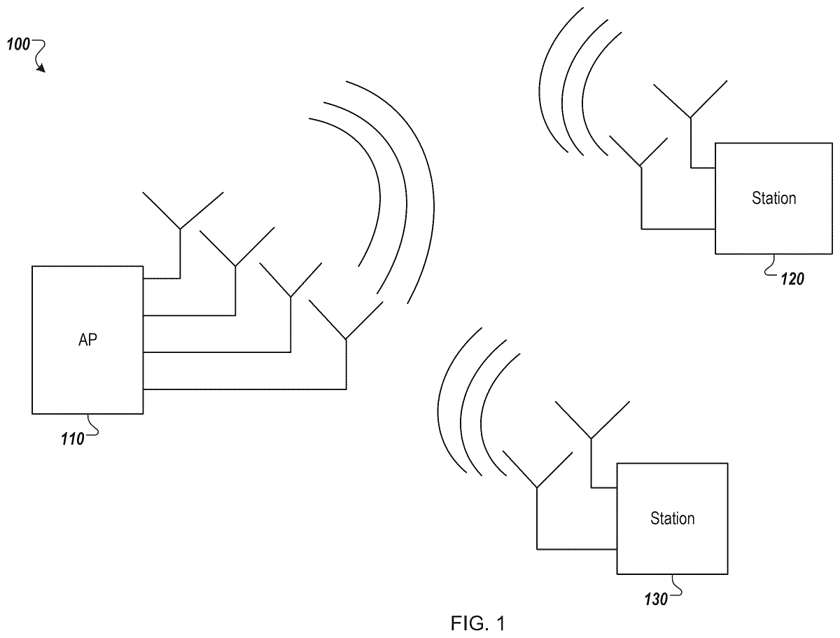

As illustrated in the wireless network 100 in FIG. 1, an AP 110 may communicate with one or more stations 120, 130. The AP 110 may have multiple antennas. The one or more stations 120, 130 may have multiple antennas. The AP may transmit simultaneously to the one or more stations 120, 130 e.g., using MU-MIMO and/or OFDMA.

In MU-MIMO and OFDMA, there may be mutual dependencies between the simultaneously served STAs. Controlling the link rates independently may be inefficient. And a joint adaptation, based on a trial-and-error approach like Minstrel may be slow. In addition, features like unequal modulation per spatial stream and bit loading may be used, which may increase the number of possible PHY settings.

Link adaptation, the identification of the best possible physical layer link settings to be used, may be used in WLAN transmission to ensure reliable transmission at high performance. Trial-and-error-based methods may be used to do link adaptation. But with additional features introduced in recent WLAN generations, trial and error methods may become more and more inefficient, because the number of possible settings may increase. A fast and reliable link adaptation mechanism may be used, which may be based on receiver feedback like channel sounding feedback and additional feedback like signal-to-noise ratio (SNR) margin feedback.

Instead of testing various settings by sending data packets, a prediction of the link quality (e.g., packet error rate and throughput) may be used for the link adaptation decision. A wide range of parameters may be tested without a loss of data packets. The predicted link quality may be derived from the channel estimation feedback from the stations and additional feedback from data packets, e.g., packet error rate (acknowledgements) and SNR margin feedback.

In a trial-and-error approach, link adaptation may be based on the Minstrel algorithm, which may not use receiver feedback except the acknowledgements to estimate the packet error rate. Hereby, some of the data packets may be transmitted with different transmission settings to test whether they work better than the current settings. When this is the case, the updated settings may become the main settings and the other settings may be tested. This may cause an increase of packet loss for testing and the control may be slow.

In addition, stations may provide modulation and coding scheme (MCS) feedback, which may be recommended modulation and coding scheme for the receive signal quality the stations observe. However, it may be difficult to process for the access point because the access point may jointly optimize the transmission to multiple STAs, which may change the receive signal quality. From the MCS feedback, it may be difficult to predict the best modulation and coding scheme settings after a change of transmit settings such as transmit power, beamforming/precoding coefficients, number of spatial streams per station, and other parameters.

Instead of a trial-and-error approach, the optimal transmission settings may be estimated, based on sounding feedback from the receiver. The packet error rate may be estimated, based on SNR measurements, a prediction of the precoding gain/loss and/or the receiver SNR margin γ.

A fast link adaptation method, which may be based on a prediction of the link quality measure of interest, e.g., goodput or packet error rate, may be used based on receiver feedback and the SNR gap to capacity. In one example, the SNR gap to capacity may be estimated by the transmitter, based on the observed packet error rate (PER). In another example, the SNR gap to capacity may be communicated from the receiver to the transmitter. In another example, the STA may provide SNR margin feedback in addition to the acknowledgement to allow a more precise control of the SNR gap control without causing an increased packet error rate.

Based on sounding feedback, packet error rate (PER), and SNR margin, the AP may predict throughput and PER for the settings of interest, e.g., modulation and coding scheme, transmit power, number of spatial streams, and transmit bandwidth. The link adaptation method may be faster, may allow for joint optimization of MU-MIMO and OFDMA transmissions, and may not cause packet errors with probing packets, which may occur with the Minstrel algorithm.

Furthermore, features like unequal MCS per spatial stream or bit loading may be implemented, which may increase the parameter search space and make the use of trial-and-error methods infeasible. With SNR margin feedback, packet errors due to changes of channel conditions as well as packet errors from testing PHY settings may be avoided.

An access point may include a processing device that may: identify, at the AP, one or more measurement inputs from one or more of a sounding packet or a data packet; identify, at the AP, one or more link settings; and compute, at the AP, one or more predicted performance parameters based on the one or more measurement inputs and the one or more link settings.

Fast link adaptation may use receiver measurement from the channel sounding to perform link adaptation. Fast link adaptation may be based on two components, performance prediction and a parameter control loop. The performance prediction may be based on measurement inputs, which may be available from channel sounding and from data packets. Based on the measurements, which may be used with certain active link settings, the performance with other settings may predicted. The parameter control loop may identify settings to be tested and select updated settings to increase the link quality relative to the baseline.

In one example, the one or more link settings may include one or more of MCS, number of spatial streams, transmit power, bandwidth, a set of simultaneously served stations (STAs), or an association of STAs to APs. The MCS may be a combined metric of the constellation size (binary phase shift keying (BPSK), 4-quadrature amplitude modulation (QAM), 16-QAM, . . . , 4k-QAM) and the forward error correction (FEC) code rate (1/2, 2/3, 3/4, or 5/6). With unequal modulation, QAM constellation size and FEC code rate may be controlled separately. The number of spatial streams may be one of the link settings. The transmit power bandwidth may be e.g., 20 MHZ, . . . , 320 MHz for a selected band. The set of simultaneously served STAs (MU-MIMO) may be an association of STAs to APs (e.g., extended service set (ESS)).

The one or more measurement inputs may include one or more of: a signal-to-noise ratio (SNR) per spatial stream and carrier group, a compressed channel estimation feedback, a packet error rate, an SNR margin per spatial stream, or an SNR margin per spatial stream and carrier group. The measurement inputs may be used to predict performance. The SNR per spatial stream and carrier group may be obtained from the sounding packet. The compressed channel estimation feedback may be obtained from the sounding packet. The packet error rate of the data packet may be obtained from acknowledgements. The SNR margin γ per spatial stream or per spatial stream and carrier group may be obtained from the data packet.

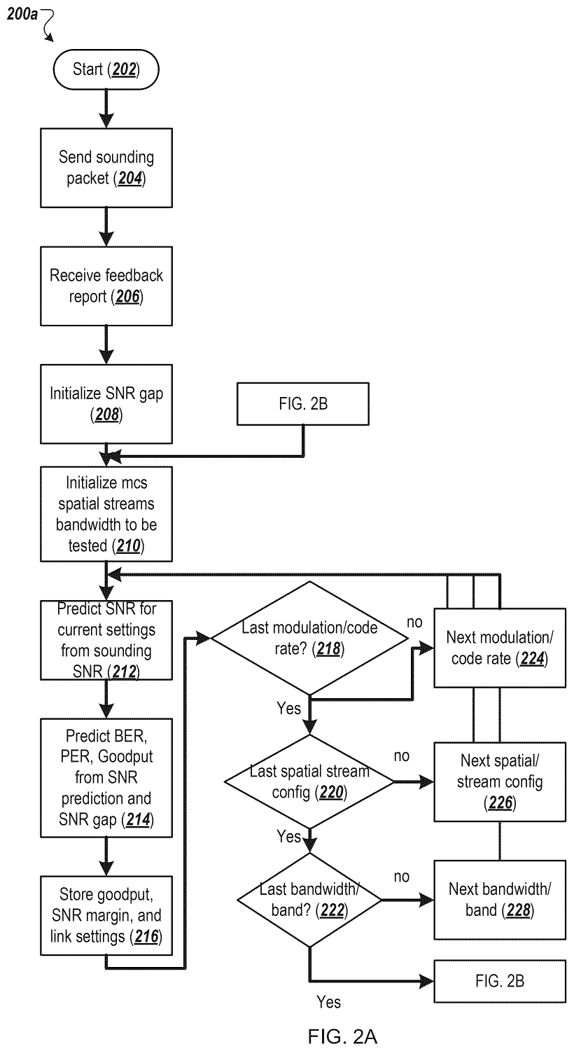

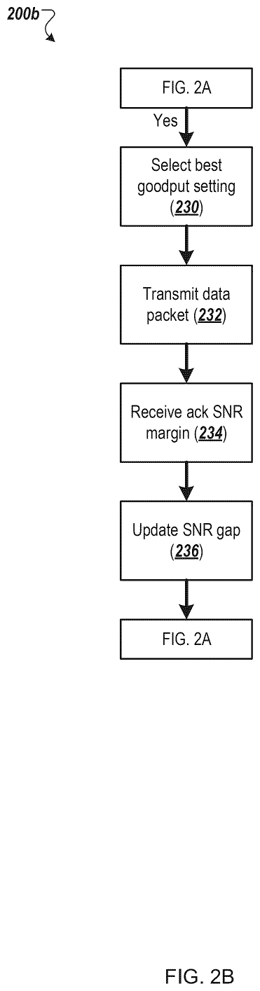

As illustrated in FIG. 2, a procedure 200a, 200b for the example of controlling modulation and code rate, spatial streams, and bandwidth mode is provided. The operations may include one or more of the prediction of SNR for various PHY settings, the prediction of goodput, or the SNR gap control. The operations may include compute, at the AP, the one or more predicted performance parameters include one or more of predicted signal-to-noise ratio (SNR) or a predicted goodput. The operations may include compute, at the AP, the predicted SNR based on an SNR received from a sounding packet. The operations may include compute, at the AP, one or more of a bit error rate, packet error rate, or the goodput based on the predicted SNR and an SNR gap. The operations may include send, from the AP to a STA, a sounding packet. The operations may include receive, at the AP from the STA, a feedback report. The operations may include initialize, at the AP, a signal-to-noise ratio (SNR) gap. The operations may include receive, at the AP, an SNR margin. The operations may include update, at the AP, the SNR gap based on the SNR margin.

The procedure 200a, 200b may start 202 and may include sending a sounding packet e.g., from an AP, as shown in operation 204. The AP may receive a feedback report e.g., from a STA, as shown in operation 206. The AP may initialize an SNR gap, as shown in operation 208. The AP may initialize the MCS, the spatial streams, and bandwidth to be tested, as shown in operation 210. The AP may predict the SNR for the current settings from the sounding SNR, as shown in operation 212. The SNR prediction and the SNR gap may be used to predict the BER, the PER, and/or the goodput, as shown in operation 214. The goodput, SNR margin, and/or link settings may be stored, as shown in operation 216.

When the last modulation and/or coding rate has not been identified, as shown in operation 218, then the next modulation and/or coding rate may be identified, as shown in operation 224. When the next modulation and/or coding rate has been identified, then the procedure may proceed to operation 212, 214, 216, and back to operation 218. When the last modulation and/or coding rate has been identified, as shown in operation 218, then the procedure may be proceed to operation 220.

When the last spatial stream configuration has not been identified, as shown in operation 220, then the next spatial stream configuration may be identified, as shown in operation 226. When the next spatial stream configuration has been identified, then the procedure 200a, 200b may proceed to operation 212, 214, 216, 218, and back to operation 220. When the last spatial stream configuration has been identified, then operation 222 may be executed.

When the last bandwidth and/or band has not been identified, as shown in operation 222, then the next bandwidth and/or band may be identified, as shown in operation 228. When the next bandwidth and/or band has been identified, then the procedure 200a, 200b may proceed to operation 212, 214, 216, 218, 220, and back to operation 222. When the last bandwidth and/or band has been identified, then operation 230, as illustrated in FIG. 2B, may be executed.

As illustrated in FIG. 2B, an AP may select a best goodput setting, as shown in operation 230. The AP may transmit a data packet, as shown in operation 232. The AP may receive an acknowledgement of an SNR margin, as shown in operation 234. The AP may update the SNR gap, as shown in operation 236. The AP may loop back to perform operation 210 (e.g., initializing the MCS, spatial streams, and/or bandwidth to be tested).

### Link Quality Prediction

There are several link quality parameters. One link quality parameter may be error-free throughput or goodput, e.g., the data rate of successfully received packets. When the PHY parameters are set aggressively, error-free throughput may drop due to packet losses and when the parameters are set conservatively, throughput may be limited by the PHY rate. Latency is another link quality parameter. Frequent retransmissions may cause an increase of latency and therefore, a low packet error rate may enhance latency. In general, there may be a packet error rate PERₗᵢₘᵢₜ that may not be exceeded to achieve high rates and low latency.

### Effective Throughput

The goodput may depend on the PHY rate and the packet error rate according to:

$${R}_{good} = ( 1 - PER ) {R}_{PHY}$$

The PHY rate may depend on the PHY settings, which may be e.g., MCS, bandwidth, and/or guard interval. The bandwidth may define the number of carriers K. The guard interval may define the symbol length t_{sym}. The MCS may define the code rate K/N and the constellation size b.

With that, the PHY rate may be

$${R}_{P H Y} = \frac{{N}_{D B P S}}{{t}_{s y m}}$$

with

$${N}_{D B P S} = ⌊ \frac{Kb}{N} ⌋ .$$

N_{DBPS} may be the number of data bits per orthogonal frequency-division multiplexing (OFDM) symbol.

TABLE 1
Bandwidth, number of carriers, and subcarrier spacing.

| | | | | | |
|---|---|---|---|---|---|
| Bandwidth | 20 | 40 | 80 | 160 | 320 |
| K | 242 | 484 | 980 | 1960 | 3920 |
| Δf | 78.125 | 78.125 | 78.125 | 78.125 | 78.125 |
| | kHz | kHz | kHz | kHz | kHz |

As provided in Table 1, the relation between the bandwidth, the number of carriers K, and the subcarrier spacing Δf is provided. For example, for bandwidth of 20 Hz, the number of carriers is 242 and the subcarrier spacing is 78.125 kHz. The subcarrier spacing may be 78.125 kHz for the different bandwidths and number of carriers provided.

TABLE 2
Guard Interval and symbol length for subcarrier
spacing, Δf = 78.125 kHz.

| | | | | | | |
|---|---|---|---|---|---|---|
| GI | 0.8 | μs | 1.6 | μs | 3.2 | μs |
| t_{sym} | 13.6 | μs | 14.4 | μs | 16 | μs |

As provided in Table 2, the relation between the guard interval and the symbol length is provided. For example, when the guard interval is 0.8 μs, then the symbol length may be 13.6 μs. As shown in Table 2, additions to the guard interval add to the symbol length. For example, for a guard interval of 3.2 μs, the symbol length is 2.4 μs greater than the symbol length for a guard interval of 0.8 μs-which is equal to the difference in guard interval length.

TABLE 3
Guard Interval and symbol length for subcarrier
spacing, Δf = 312.5 kHz

| | | | | |
|---|---|---|---|---|
| GI | 0.4 μs | 0.8 | μs | 1.6 μs |
| t_{sym} | 3.6 μs | 4 | μs | 4.8 μs |

As provided in Table 3, the relation between the guard interval and the symbol length is provided for subcarrier spacing of 312.5 kHz.

TABLE 4
modulation and coding scheme, code rate, and constellation size.

| MCS | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| K/N | 1/2 | 1/2 | 3/4 | 1/2 | 3/4 | 2/3 | 3/4 | 5/6 | 3/4 | 5/6 | 3/4 | 5/6 | 3/4 | 5/6 |
| b | 1 | 2 | 2 | 4 | 4 | 6 | 6 | 6 | 8 | 8 | 10 | 10 | 12 | 12 |

As shown in Table 4, the MCS, code rate, and constellation size are provided. For example, for MCS of 0, the code rate is 1/2, and the constellation size is 1.

The packet error rate may depend on the packet size and the bit error rate. When the packet size is variable and traffic-dependent, a generic average packet size may be assumed, e.g., 1500 Bytes. For simplicity, the following approximation may be used:

$$PER = \{ \begin{matrix}0 & for BER \leq {BER}_{target} \\ 1 & otherwise\end{matrix}$$

For a more accurate approximation, the PER may be derived from the BER according to

$$P E R = 1 - {( 1 - B E R )}^{{N}_{bit , packet}}$$

This may be the worst-case assumption (uncorrelated errors). In practice, the PER may be a bit lower, as the LDPC may cause block errors of a few bits.

### Bit Error Rate Prediction

The bit error rate may depend on the LDPC code rate K/N and the signal quality. When the signal quality (e.g., the signal-to-noise ratio, SNR) is different on the subcarrier and spatial stream, an averaged link quality measure may be used. Mutual information I(x,y) may be an appropriate measure.

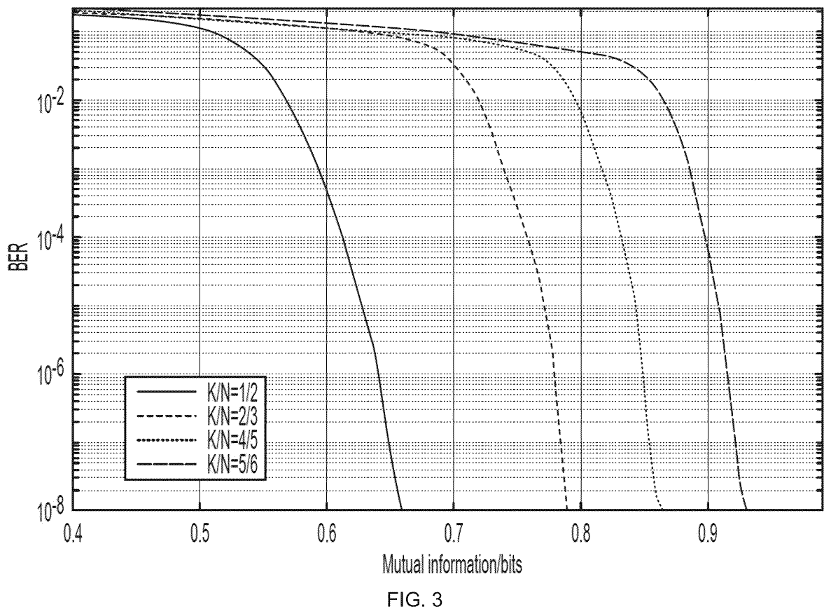

The dependency between mutual information (in bits/transmitted bit) and the LDPC bit error rate may be provided in the graph 300 in FIG. 3. The graph 300 shows that for a code rate of K/N=1/2, there was a BER of about 10⁻⁸ when the mutual information was about 0.65 bits/transmitted bit. The graph 300 shows that for a code rate of K/N=2/3, there was a BER of about 10⁻⁸ when the mutual information was about 0.78 bits/transmitted bit. The graph 300 shows that for a code rate of K/N=4/5, there was a BER of about 10⁻⁸ when the mutual information was about 0.86 bits/transmitted bit. The graph 300 shows that for a code rate of K/N=5/6, there was a BER of about 10⁻⁸ when the mutual information was about 0.93 bits/transmitted bit.

The PHY link quality measurement available may be SNR. Therefore, mutual information may be derived from the SNR per carrier and the averaged mutual information may be used to predict the BER. The dependency between capacity C and SNR may be given by

$$C = {\sum }_{k = 1}^{K} {\sum }_{l = 1}^{L} {log}_{2} ( 1 + S N {R}_{l}^{( k )} ) .$$

With an SNR gap Γ, the rate R may be given by

$$R = {\sum }_{k = 1}^{K} {\sum }_{l = 1}^{L} {log}_{2} ( 1 + \frac{S N {R}_{l}^{( k )}}{Γ} ) .$$

The mutual information (MI) per bit (e.g., GMI) may be approximated according to

$$I ( x , y ) = \frac{1}{b K L} {\sum }_{k = 1}^{K} {\sum }_{l = 1}^{L} {log}_{2} ( 1 + \frac{S N {R}_{l}^{( k )}}{Γ} ) .$$

However, this equation does not consider that MI per carrier may be limited for a QAM constellation. The bounded capacity may be approximated by

$$I ( x , y ) = \frac{1}{b K L} {\sum }_{k = 1}^{K} {\sum }_{l = 1}^{L} min ( {log}_{2} ( 1 + \frac{S N {R}_{l}^{( k )}}{Γ} ) , b ) .$$

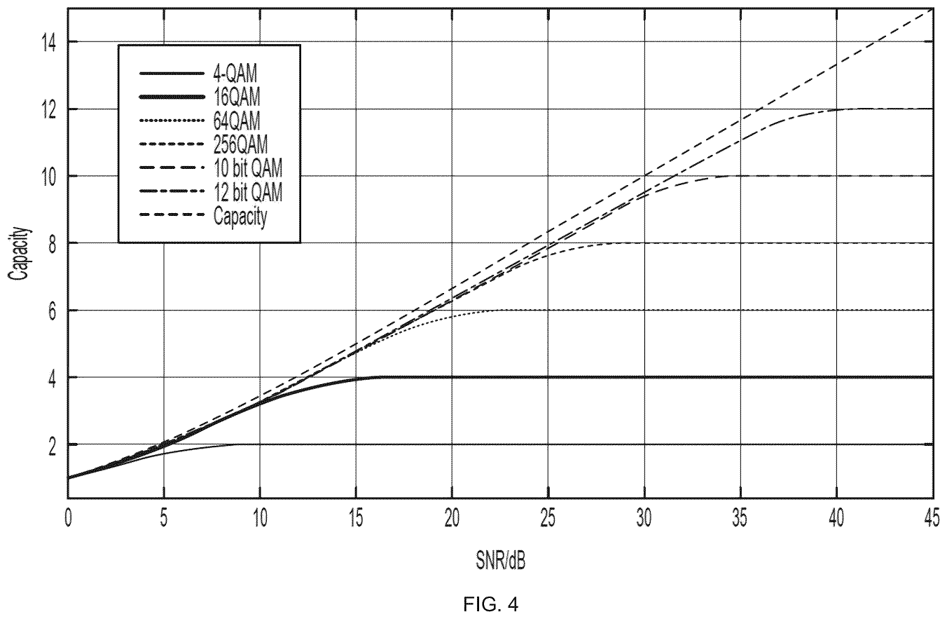

A more accurate estimation may be given by FIG. 4, which may be the capacity of QAM transmission over an additive white Gaussian noise (AWGN) channel. As shown in FIG. 4, (i) 4-QAM may provide a capacity that plateaus at about 2 bits when the SNR is about 7 dB, (ii) 16 QAM may provide a capacity that plateaus at about 4 bits when the SNR is about 15 dB, (iii) 64 QAM may provide a capacity that plateaus at about 6 bits when the SNR is about 22 dB, (iv) 256 QAM may provide a capacity that plateaus at about 8 bits when the SNR is about 27 dB, (v) 10-bit QAM may provide a capacity that plateaus at about 10 bits when the SNR is about 33 dB, and (vi) 12-bit QAM may provide a capacity that plateaus at about 12 bits when the SNR is about 40 dB.

With the MI value from these equations or from FIG. 4, the BER may be approximated with the help of BER curves characterizing the LDPC decoder, e.g., FIG. 3.

The BER and PER prediction may use SNR as an input. From the channel sounding, an estimation of the SNR for specific transmission settings may be available (e.g., beamforming transmission with the number of spatial streams, bandwidth, and power used for the sounding packet). To derive the performance for other link settings, the SNR for these settings may be predicted from the available measurements.

### Sounding SNR Measurement

Sounding feedback may be used to predict performance of a data packet transmission. The sounding feedback may be defined as follows: For the carrier, MIMO transmission may be described by

$$y = HPu + n$$

Where H is the channel matrix, P is the precoder matrix and P=I is used for channel sounding. The transmit signal vector may be u and the receiver noise may be n. The receive signal vector may be y. With T sounding symbols, which form an orthogonal sequence for transmit antennas, the channel estimation may be performed.

With knowledge of the transmitted and received signals, the estimated channel Hₑₛₜ may be given by (for orthonormal vectors U):

$${H}_{est} = \frac{1}{T} {\sum }_{t = 1}^{T} {y}_{t} {u}_{t}^{H}$$

T may be the number of long training field (LTF) symbols. In addition, the receiver noise may be estimated, e.g., the noise variance σ².

The STA may perform a singular value decomposition of the channel estimate Hₑₛₜ according to

Hₑₛₜ=USV^{H}.

When using the compressed feedback report, the 1 to Nᵣₓ columns of V may be requested, where Nᵣₓ may be the number of receive antennas of the STA. In addition to the V feedback, an estimate of the beamforming SNR may be derived from the singular values according to:

$$S N {R}_{l} = \frac{{s}_{l}^{2}}{{σ}^{2}} .$$

When sending a data packet using beamforming and the same number of spatial streams, transmit power and bandwidth as for the sounding packet and no changes of the channel due to aging, the same SNR may be expected.

Based on the difference between the assumptions of the SNR estimation during sounding and the actual or target transmission settings, the expected SNR of the transmission settings may be derived.

Performance Prediction for Different PHY Settings from Sounding

The sounding SNR feedback may be based on the assumption of beamformed transmission with the requested number of spatial streams and antennas. Link adaptation may test different bandwidth and spatial stream settings. In addition, the transmit power or the power scaling may change, especially when the data packet is transmitted in MU-MIMO or OFDMA mode, where a different gain scaling may be used, depending on the STAs served simultaneously.

### Spatial Stream Change

For predictive link adaptation with optimization of the number of spatial streams L, sounding feedback may be requested with the maximum L, e.g., L_{sounding}=min (Nₜₓ, Nᵣₓ). The SNR with the actual number of spatial streams may be

$$S N {R}_{e s t , l}^{( k )} = min ( \frac{{L}_{s o u n d i n g}}{L} S N {R}_{s o u n d i n g}^{( k )} , {SNR}_{max} ) .$$

Hereby, it may be assumed that the spatial stream 1 may have the highest SNR and spatial stream L_{sounding} the lowest. Thus, there may be two factors increasing the mutual information per bit when reducing the number of spatial streams, the increased average SNR of the remaining spatial streams and the increased power per spatial stream. To avoid an over-estimation of the SNR, which may be limited by the transmit SNR, the upper bound SNRₘₐₓ may be introduced.

### Bandwidth Change

For a change of bandwidth, a similar approach may be used. As for the spatial streams, sounding with the maximum bandwidth of interest may be performed.

$$S N {R}_{e st , l}^{( k )} = min ( \frac{{K}_{s o u n d i n g}}{K} S N {R}_{s o u n d i n g}^{( k )} , {SNR}_{max} ) ,$$

which may be valid for the subset of carriers k to be used for data transmission.

### Precoding Mode Change

The SNR feedback from the sounding assumes point-to-point MIMO transmission. In case of OFDMA transmission, the per-carrier transmit power may differ (k), between sounding and data packet, e.g., p_{sounding}^{(k)}≠p_{data}^{(k)}.

In the case of MU-MIMO, the precoder gain scaling may have an impact on SNR, too. For example, for zero forcing (ZF) precoding to STAs 1, . . . , M, the precoder may be given by

$${P}^{( k )} = {[ \begin{matrix}{V}_{1}^{( k )} \\ ⋮ \\ {V}_{M}^{( k )}\end{matrix} ]}^{- 1} diag ( [ {s}_{1}^{( k )} … {s}_{L}^{( k )} ] ) .$$

Hereby, the gain scaling coefficients sₗ^{(k)} may be selected to satisfy the power constraint, e.g., Σ_{K=1}^{K} trace (P^{(k)}P^{(k),H})≤pₘₐₓ. The SNR change with respect to the transmit gains may be given by

$$S N {R}_{e st , l}^{( k )} = min ( {\vert {s}_{l}^{( k )} \vert}^{2} {SNR}_{s ounding}^{( k )} , {SNR}_{max} ) .$$

For interference allowing precoding, the SNR may be reduced by the interference. In this case, the SNR may be given by

$$S N {R}_{e s t , l}^{( k )} = \frac{{\vert {g}_{l}^{( k ) , T} {H}^{( k )} {p}_{l}^{( k )} \vert}^{2}}{{g}_{l}^{( k ) , T} {σ}^{2} {g}_{l}^{( k ) , *} + {\sum }_{d \neq l} {\vert {g}_{l}^{( k ) , T} {H}^{( k )} {p}_{d}^{( k )} \vert}^{2}}$$

With the receive equalizer

$${G}^{( k )} = [ \begin{matrix}{g}_{1}^{( k ) , T} \\ ⋮ \\ {g}_{L}^{( k ) , T}\end{matrix} ]$$

and the transmit precoder

$${P}^{( k )} = [ {p}_{1}^{( k )} … {p}_{L}^{( k )} ]$$

### Transmit (TX) Power Change

Transmit power may be changed, not only to satisfy the transmit power constraints, but also for power saving or to enhance the transmitter linearity. The SNR change with respect to the transmit gains may be given by

$$S N {R}_{e st , l}^{( k )} = min ( {\vert {s}_{l}^{( k )} \vert}^{2} {SNR}_{s ounding}^{( k )} , {SNR}_{max} ) .$$

SNRₘₐₓ may be a simple approximation of the TX SNR limitation. For a more accurate model, the following equation may be used.

$$SN {R}_{e s t , l}^{( k )} = \frac{{\vert {g}_{l}^{( k ) , T} {H}^{( k )} {p}_{l}^{( k )} \vert}^{2}}{\begin{matrix}{g}_{l}^{( k ) , T} ( {σ}^{2} I + {C}_{n , RX} ) {g}_{l}^{( k ) , *} + \\ {Σ}_{d \neq l} {\vert {g}_{l}^{( k ) , T} {H}^{( k )} {p}_{d}^{( k )} \vert}^{2} + {g}_{l}^{( k ) , T} {H}^{( k )} {C}_{n , T X} {H}^{( k )} {g}_{l}^{( k ) , *}\end{matrix}} .$$

Hereby the receiver noise covariance may be

$${C}_{n , R X} = ( \frac{1}{K S N {R}_{R X}} {\sum }_{k = 1}^{K} diag ( {H}^{( k )} {P}^{( k )} {P}^{( k ) , H} {H}^{( k ) , H} ) ) ,$$

and the transmitter noise covariance may be

$${C}_{n , T X} = ( \frac{1}{K S N {R}_{T X}} {\sum }_{k = 1}^{K} diag ( {P}^{( k )} {P}^{( k ) , H} ) ) .$$

### SNR Gap Control

An access point (AP) may include a processing device operable to: receive, at the AP from a station (STA), a signal-to-noise ratio (SNR) margin; compute, at the AP, a predicted SNR margin based on a performance estimation; and compute, at the AP, an SNR gap based on a difference between the predicted SNR margin and the SNR margin. The processing device may compute, at the AP, the predicted SNR margin based on a difference between an actual SNR and a required SNR.

The performance prediction equations may be based on two parameters, the SNR and the SNR gap Γ. The SNR may be predicted for various transmission settings. For a precise link adaptation, the SNR gap Γ, which may be a receiver property, may be known to the transmitter.

Hereby, SNR gap Γ may define the difference between channel capacity or a generic receiver model and the actual receiver implementation. In case of MU-MIMO transmission to multiple STAs m=1, . . . , M, there may be an SNR gap Γₘ per STA m. In case of multiple spatial streams l=1, . . . , L, a different SNR gap per spatial stream Γₗ may be required. The same may be true, e.g., for low and high SNR and for different frequency bands.

To adjust the SNR gap used by the transmitter for link adaptation to the actual receiver behavior, receiver feedback from data packets may be used, which may be the packet error rate (e.g., from acknowledgements), and additional SNR margin feedback.

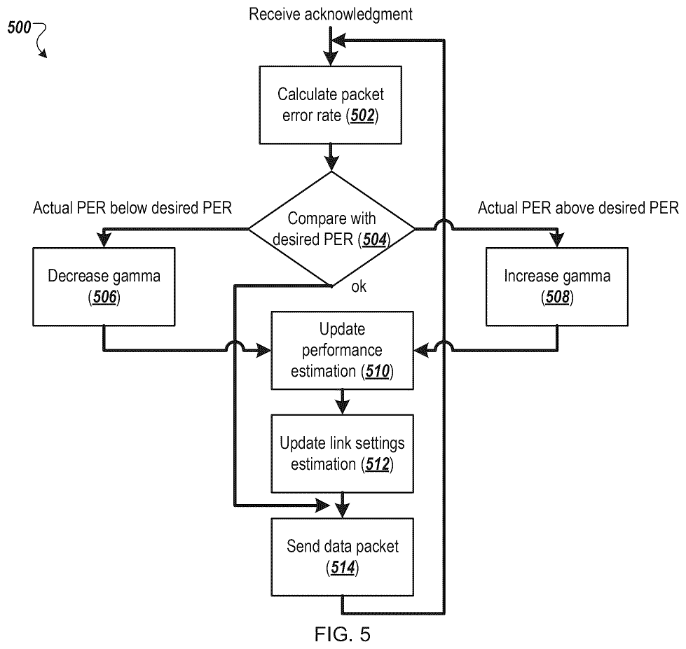

When there are acknowledgements for feedback, the SNR margin update may be performed as shown in FIG. 5. The SNR gap may be increased when the observed PER is high and decreased when the observed PER is low. This may not allow a fine control, e.g., per spatial stream (for unequal modulation) or per frequency (for bit loading).

In the procedure 500 illustrated in FIG. 5, an AP may receive an acknowledgement. The AP may calculate a packet error rate, as shown in operation 502. The AP may compared the packet error rate with a target packet error rate, as shown in operation 504. When the actual packet error rate is below the target packet error rate, the AP may decrease gamma, as shown in operation 506. When the actual packet error rate is above the target packet error rate, the AP may increase the gamma, as shown in operation 508. When the gamma has been decreased, as shown in operation 506, or the gamma has been increased, as shown in operation 508, the AP may update the performance estimation, as shown in operation 510. The AP may update the link settings estimation, as shown in operation 512. The AP may then send a data packet, as shown in operation 514. Alternatively or in addition, when AP compares the packet error rate with the target packet error rate, as shown in operation 504, and determines that the packet error rate may skip adjustment, then the AP may send the data packet, as shown in operation 514.

When SNR margin feedback γₘₑₐₛ from the receiver is available in the acknowledgement packets, the SNR margin feedback may be compared with the expected SNR margin γ_{predict} from the performance estimation. With the difference between γₘₑₐₛ from the receiver and margin γ_{predict} from the last link adaptation decision, the SNR gap may be updated.

$${Γ}_{n e w} [ dB ] = {Γ}_{o l d} [ dB ] + α ( Δ Γ [ dB ] )$$

$$ΔΓ [ dB ] = {γ}_{predict} - {γ}_{m e a s}$$

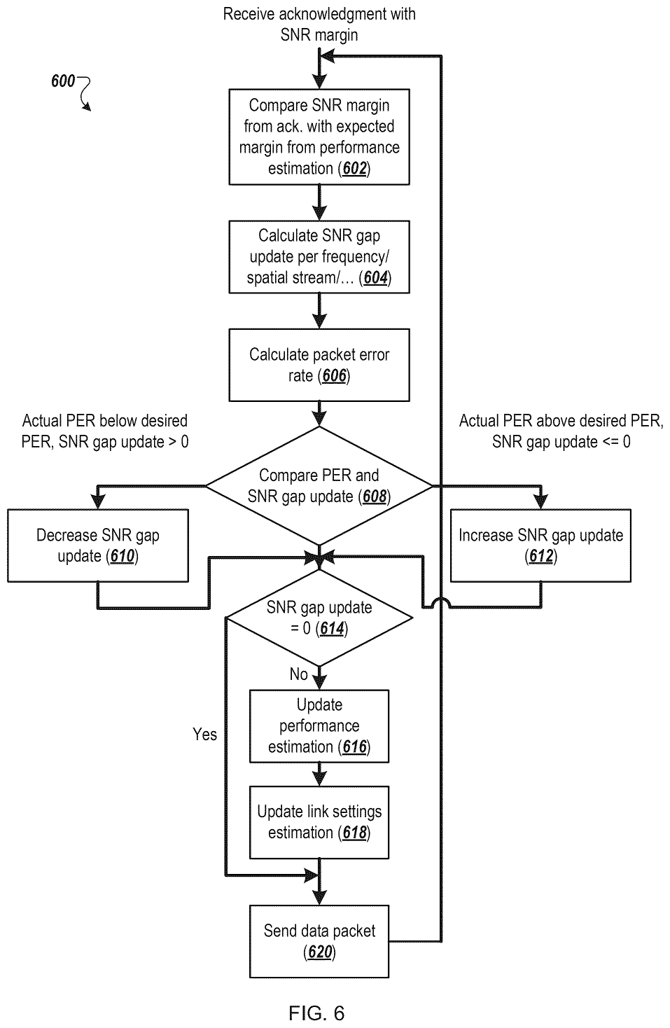

The procedure, as illustrated in FIG. 6 may include, computing, at the AP, a packet error rate; and computing, at the AP, an SNR gap update based on the packet error rate.

In a procedure 600, an AP may receive an acknowledgement with SNR margin. The AP may compare the SNR margin from the acknowledgement with the expected margin from a performance estimation, as shown in operation 602. The AP may calculate an SNR gap update per frequency, per spatial stream, or the like, as shown in operation 604. The AP may calculate a packet error rate, as shown in operation 606. The AP may compare the packet error rate and the SNR gap update, as shown in operation 608. When the actual packet error rate is below the target packet error rate and the SNR gap update is greater than 0, then the AP may decrease the SNR gap update, as shown in operation 610. When the actual packet error rate is above the target packet error rate and the SNR gap update is less than or equal to 0, then the AP may increase the SNR gap update, as shown in operation 612.

As shown in operation 614, when the SNR gap update is not equal to 0, then the AP may update the performance estimation, as shown in operation 616, and update the link settings estimation, as shown in operation 618, before sending the data packet 620. When the SNR gap update is equal to 0, then the AP may send the data packet 620. After sending the data packet, the AP may proceed to receive an acknowledgment with SNR margin, and repeat the procedure 600.

At the transmitter and receiver sides, the snr margin γ may be calculated. The SNR margin (in dB) is defined as the difference between actual and required SNR SNR_{req} according to

$$γ [ dB ] = SNR [ dB ] - {SNR}_{req} ( \frac{K}{N} , b ) [ dB ] .$$

In accordance with the different methods to predict the BER, there may be different methods to predict the required SNR SNR_{req}. The processing device may compute, at the AP, the required SNR using one or more of a Gaussian capacity, a quadrature amplitude modulation (QAM) capacity, or a forward error correction (FEC) model.

### Required SNR Method 1 (Gaussian Capacity):

The required SNR may be determined in different ways. One method may include the SNR gap to capacity Γ which may be provided by

$$S N {R}_{req} = ( {2}^{\frac{K}{N} b} - 1 ) Γ$$

where Γ may be a receiver parameter. This equation may be based on channel capacity with Gaussian modulation (e.g., capacity

$$C = {log}_{2} ( 1 + \frac{S N R}{Γ} ) ) .$$

Thus, there may be the SNR gap of Γ≈1.5 dB from the difference between QAM modulation and Gaussian modulation.

### Required SNR Method 2 (QAM Capacity):

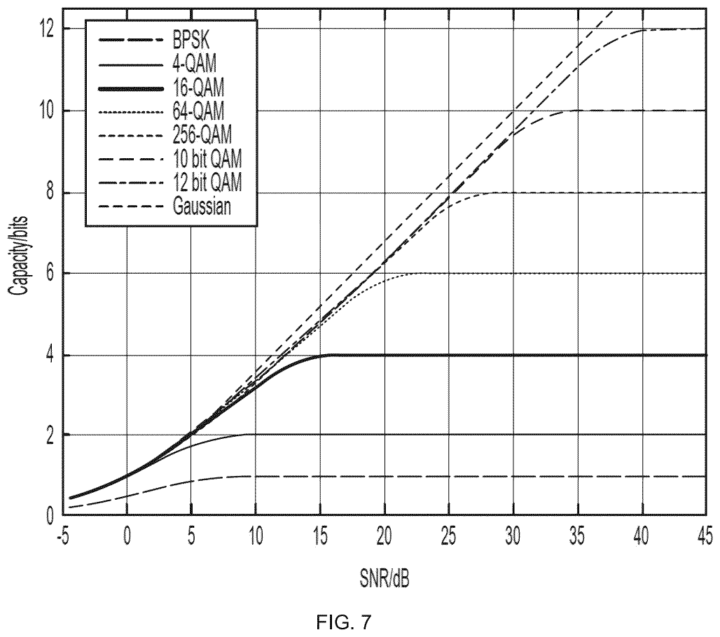

With knowledge of the actual QAM modulation size, the capacity of the actual QAM constellation may be used. Without a simple equation for the capacity of a certain QAM constellation, the dependency may be stored in a table which may contain the information shown in FIG. 7.

FIG. 7 illustrates the dependency between capacity (in bits) and SNR (in dB) for WLAN QAM constellations. For BPSK, the capacity may plateau at about 1 bit when the SNR is about 5 dB. For 4-QAM, the capacity may plateau at about 2 bits when the SNR is about 7 dB. For 16-QAM, the capacity may plateau at about 4 bits when the SNR is about 15 dB. For 64-QAM, the capacity may plateau at about 6 bits when the SNR is about 22 dB. For 256-QAM, the capacity may plateau at about 8 bits when the SNR is about 27 dB. For 10-bit QAM, the capacity may plateau at about 10 bits when the SNR is about 33 dB. For 12-bit QAM, the capacity may plateau at about 12 bits when the SNR is about 40 dB. An equation may provide the SNR_{req} as follows:

$$S N {R}_{req} = SNR : ( C ( b ) = b \frac{K}{N} ) Γ$$

Still the SNR gap Γ may be used to account for the FEC characteristics and to achieve the target packet error rate.

### Required SNR Method 3 (FEC Model):

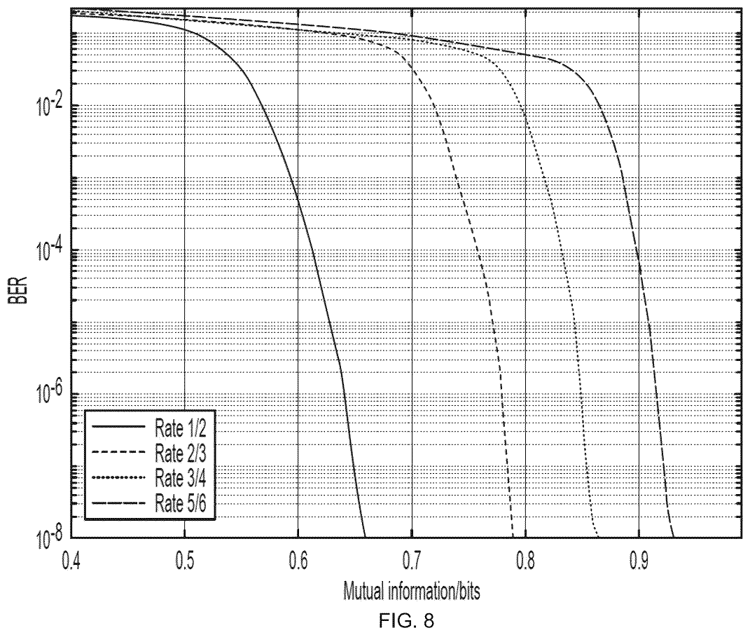

To further refine the required SNR definitions and take the FEC behavior into account, the dependency between mutual information per transmitted bit (or GMI) and the coded bit error rate, as shown in FIG. 8, may be used. With proper interleaving, this may not be dependent on the constellation size or the individual SNRs.

For example, for a code rate of 1/2, mutual information of about 0.65 may correspond with a BER of about 10⁻⁸. For a code rate of 2/3, mutual information of about 0.79 may correspond with a BER of about 10⁻⁸. For a code rate of 3/4, mutual information of about 0.87 may correspond with a BER of about 10⁻⁸. For a code rate of 5/6, mutual information of about 0.93 may correspond with a BER of about 10⁻⁸.

For a given code rate and target BER, the GMI may be derived from FIG. 8 in the first operation. With the GMI value, the required SNR may be taken from the capacity-SNR dependency of FIG. 7 according to:

$$S N {R}_{req} = SNR : ( C ( b ) = GMI ( \frac{K}{N} , BE {R}_{t a rget} ) ) Γ .$$

Based on one or more of methods 1-3, the required SNR for FEC code rate and constellation size may be derived to provide Table 3.

TABLE 3
Required SNR for Various Constellation
Sizes b and FEC code rates K/N

| SNR_{req}/dB | K/N = 1/2 | K/N = 2/3 | K/N = 3/4 | K/N = 5/6 |
|---|---|---|---|---|
| B = 1 | −0.94 | 0.87 | 1.83 | 3.06 |
| B = 2 | 2.06 | 3.87 | 4.84 | 6.06 |
| B = 4 | 7.60 | 9.89 | 11.05 | 12.45 |
| B = 6 | 12.20 | 15.09 | 16.48 | 18.10 |
| B = 8 | 16.47 | 20.05 | 21.73 | 23.59 |
| B = 10 | 20.60 | 24.92 | 26.92 | 29.06 |
| B = 12 | 24.64 | 29.73 | 32.08 | 34.54 |

To derive the SNR margin per STA m or spatial stream/from SNR values per carrier k, the SNR may be averaged. Hereby, averaging over mutual information may be used

$${C}_{a v g , l} = {\sum }_{k = 1}^{K} {log}_{2} ( 1 + \frac{S N {R}_{l}^{( k )}}{Γ} ) .$$

The predicted SNR margin may be

$${γ}_{predict , l} [ dB ] = 10 {log}_{10} ( {2}^{{C}_{avg , l}} - 1 ) - S N {R}_{req , l} [ dB ] .$$

### Receiver SNR Margin Calculation

A station (STA) may include a processing device operable to: compute, at the STA, a signal-to-noise ratio (SNR) margin; compute, at the STA, SNR margin feedback based on the SNR margin; and send, from the STA to an access point (AP), the SNR margin feedback.

In one example, the receiver may provide SNR margin feedback, which may be a feedback per STA m or γ_{meas,l} per spatial stream l or per spatial stream l and carrier group k γ_{meas,l}^{(k)} in addition to the acknowledgements, e.g., as part of the acknowledgement packet.

The SNR margin feedback may be derived at the receiver from the data packet. SNR margin may be defined as the SNR difference between the required SNR and the actual SNR. When the actual SNR is a quantity that may not exist in the receiver (e.g., for nonlinear detection schemes), different examples may be used to determine the receiver SNR margin.

Another definition of the SNR margin may be the maximum noise increase that is acceptable to satisfy the target link quality (e.g., target PER or BER). There are various ways to derive it from receive signal.

### Method 1 (SNR-Based):

In one example, the processing device may be operable to compute, at the STA, the SNR margin based on an SNR.

In linear receivers, the SNR may be derived from the slicer errors at the receiver output. Assuming the transmit signal uₗ^{(k)}, a receive signal at the equalizer output of ûₗ^{(k)} and a hard decision output ūₗ^{(k)}, normalized to unit power. Then the receiver error may be eₗ^{(k)}=ûₗ^{(k)}−uₗ^{(k)}, which is approximated at the receiver by eₗ^{(k)}=ûₗ^{(k)}−ūₗ^{(k)}. This approximation may cause an over-estimation of the SNR (error under-estimation), but within the operating range of the receiver, the error is small. The SNR may be given by

$$S N {R}_{l}^{( k )} = \frac{1}{\frac{1}{T} {Σ}_{t = 1 , … , T} {\vert {e}_{l}^{( k ) , t} \vert}^{2}} .$$

To derive a per-stream margin from the per-carrier SNR values, the equations

$${C}_{a v g , l} = {\sum }_{k = 1}^{K} {log}_{2} ( 1 + \frac{S N {R}_{l}^{( k )}}{{Γ}_{r x}} ) and {γ}_{m e a s , l} = \frac{( {2}^{{C}_{avg , l}} - 1 )}{S N {R}_{req , l}}$$

may be used. Hereby, Γᵣₓ may be a control parameter of the receiver to maintain a certain target BER or PER, and account for the receiver and FEC characteristics. With higher Γᵣₓ, a lower BER and PER may be achieved. Hereby, Γᵣₓ may be different from the SNR gap Γ, because the transmitter and the receiver may use different required SNR values.

### Method 2 (BER-Based):

In one example, the processing device may be operable to compute, at the STA, the SNR margin based on a bit error rate (BER).

There are receiver architectures where the slicer error may not be available eₗ^{(k)}(k) and thus, SNR measurement may not be applicable. But in any case, the raw bit errors prior to FEC decoding may be counted per spatial stream BER_{raw,l}, or per spatial stream and carrier group BER_{raw,l}^{(k)}.

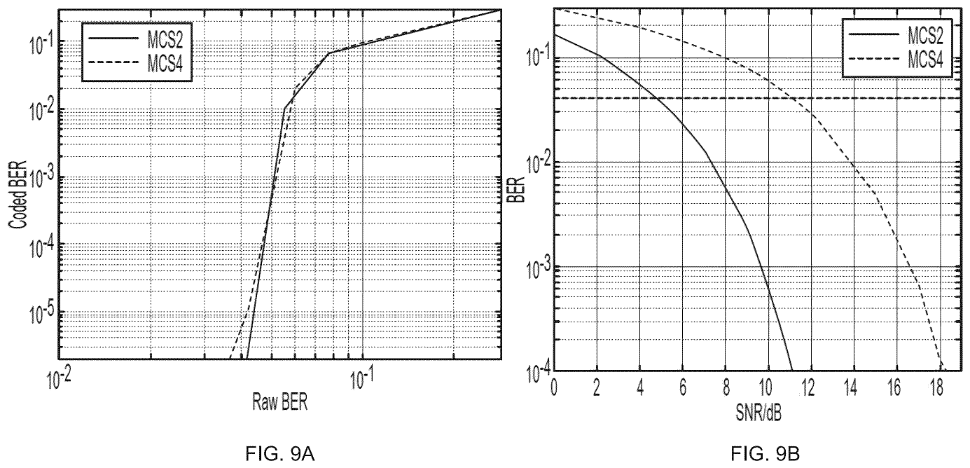

To count the bit errors, some successfully decoded FEC codewords may be re-encoded and compared to the raw bits. The relation between raw BER and coded BER may depend on the FEC settings and the constellation size. An example is given by FIG. 9A for LDPC code rate 3/4, indicating an input BER around 4e-2 for this LDPC code rate. To report SNR margin in dB, the raw BER values may be mapped to SNR. For the AWGN channel, there may be a strict dependency between BER and SNR, as shown in FIG. 9B for the example of 4-QAM (e.g., MCS2) and 16-QAM (e.g., MCS4).

### Method 3 (LLR-Based):

In one example, the processing device may compute, at the STA, the SNR margin based on log likelihood ratios (LLRs).

A receiver may use soft decision decoding. Thus, the raw BER may not be an exact method to characterize the FEC input. Soft decision decoding may use LLR as input. The statistics of the LLR values may be used to characterize the mutual information per spatial stream (and carrier) and thus, to derive the SNR margin.

Assuming a transmitted bit sequence uᵢ and the llr value llr∈{−llrₘₐₓ, . . . , llrₘₐₓ}, corresponding to the transmitted bit, the mutual information may be given by

$$I ( {u}_{i} , llr ) = {\sum }_{{u}_{i} ∈ \{ 0 , 1 \}} {\sum }_{l l r ∈ \{ - l l {r}_{max} , … , {llr}_{max} \}} {p}_{{u}_{i} , llr} ( {u}_{i} , llr ) {log}_{2} ( \frac{{p}_{{u}_{i} , llr} ( {u}_{i} , llr )}{{p}_{{u}_{i}} ( {u}_{i} ) {p}_{l l r} ( l l r )} ) .$$

Here, pᵤ_{ᵢ}(uᵢ) may be the probability to transmit bit uᵢ (usually uᵢ=0.5), pₗₗᵣ(llr) may be the probability to receive LLR value llr and pᵤ_{ᵢ}_{,llr}(uᵢ, llr) may be the probability to receive LLR value llr when transmit bit uᵢ is transmitted. The transmitted bits may be recovered, e.g., from the FEC decoder output of a successfully decoded codeword.

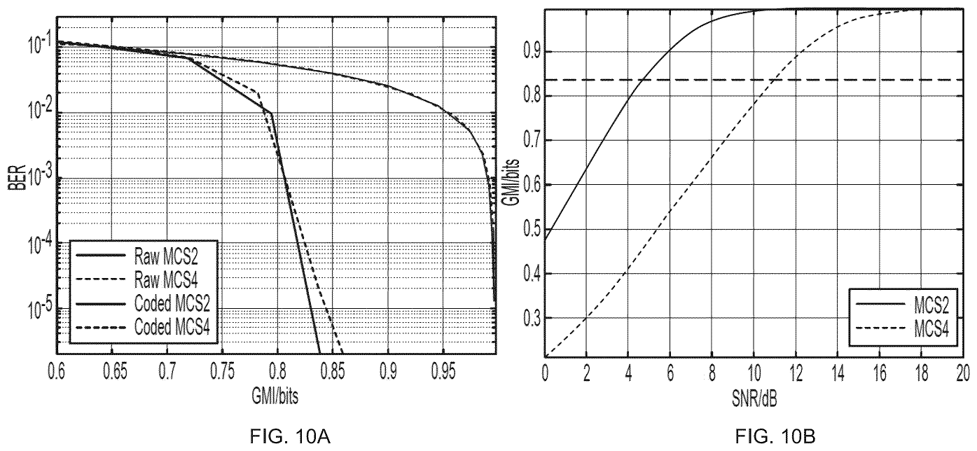

An example for the dependency between input and coded BER and mutual information may be given in FIG. 10A for MCS2 (e.g., 4-QAM, rate 3/4 code) and MCS4 (e.g., 16-QAM, rate 3/4 code). As was the case for FIG. 8, a required GMI around 0.84 may be expected for a BER around 1e-5. In FIG. 10B, the dependency between SNR and GMI for two constellation sizes (4-QAM/MCS2 and 16-QAM/MCS4) is shown. Like the SNR-based SNR margin, SNR margin may be derived from the GMI according to

$${γ}_{m e a s , l} = \frac{( {2}^{{C}_{avg , l}} - 1 )}{S N {R}_{req , l}}$$

Hereby, C_{avg,l}=GMI br. The SNR margin values computed from GMI may saturate, because the GMI curve approaches 1 for high SNR.

### Transmit Power Optimization

A processing device may adjust, at the AP, a transmit power based on the predicted SNR margin; and adjust, at the AP, a transmit power based on SNR margin feedback. Knowing the SNR margin γ, the transmit power may be reduced to gain linearity. Due to the granularity of possible modulation and code rate settings, there may be an SNR margin of up to 3 dB available. When multiple spatial streams are transmitted, the SNR margin may be different per spatial stream. Accordingly, a different transmit power reduction per spatial stream may be performed.

### Link Adaptation and Channel Aging

A processing device may compute, at the AP, updated link settings based on SNR margin feedback. Between consecutive channel soundings, the link quality (e.g., in terms of SNR) may degrade due to changes in the transmission channel (channel aging). This may cause an increase of packet errors and thus, a loss of data rate until link adaptation updates the settings. With link adaptation based on trial-and-error, this may not be avoided because link adaptation may be slow.

A processing device may perform, at the AP, updated channel sounding based on SNR margin feedback. With SNR margin feedback, the transmitter may be aware of the degradation of SNR margin and may update the link settings before the PER increases. If the observed performance degradation is high, a new sounding may be performed.

### Communication Protocol

To select the correct unequal modulation settings, SNR feedback from the receiver may be used, e.g., through a sounding packet. In addition, SNR margin feedback from the data packet may enhance the link adaptation.

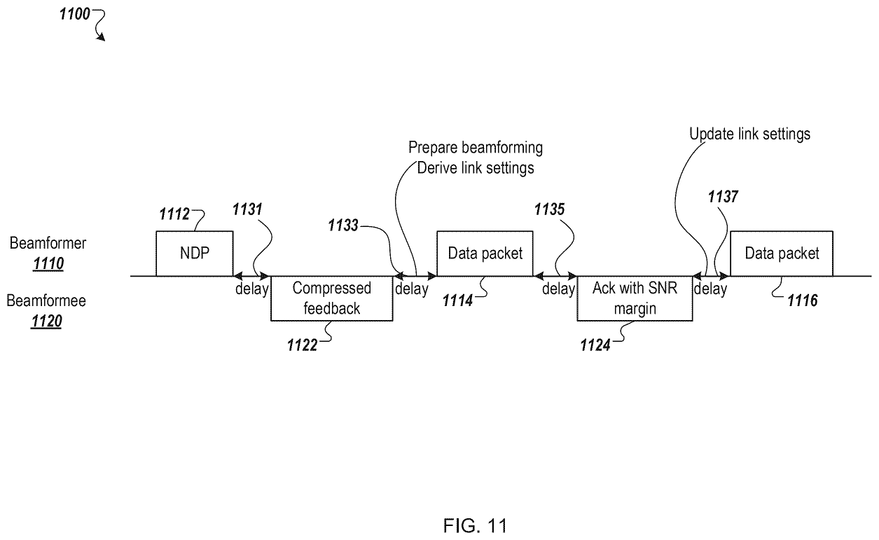

The sequence of packets for a beamformed transmission with unequal modulation is shown in FIG. 11. The diagram 1100 may include a sequence of packets between a beamformer 1110 and a beamformee 1120. The beamformer 1110 may transmit a null data packet (NDP), as shown in block 1112. Following a delay 1131, the beamformee 1120 may transmit compressed feedback, as shown in block 1122. During a delay 1133, the beamformer 1110 may prepare beamforming and derive link settings. The beamformer 1110 may transmit a data packet, as shown in block 1114. Following a delay 1135, the beamformee 1120 may transmit an acknowledgement with an SNR margin, as shown in block 1124. During a delay 1137, the beamformer 1110 may update link settings. Following the delay 1137, the beamformer may transmit the data packet 1116 with the updated settings.

That is, from the SNR of the NDP transmission, as shown in block 1112, the initial unequal modulation setting may be derived, and the data packet, as shown in block 1114, may be transmitted with the corresponding settings. Based on the acknowledgement of the data packet, the settings may be refined, using the packet error rate derived from the acknowledgement and the SNR margin per spatial stream information. The next data packet 1116 may be transmitted with the updated settings.

### Receiver Verification

For SNR margin-based link adaptation, the correctness of the SNR margin report may be verified. To test the receiver, the transmitter may implement a margin verification capability. Stable channel conditions may be used for the test, e.g., in an anechoic chamber or a wired test setup. In the first step, the transmitter may use certain settings with positive SNR margin and receive the SNR margin report from the station. The variation of the SNR margin report may be within certain accuracy limits. In the next operation, the transmitter settings may be kept, but the transmit power may be reduced by the amount that was reported as SNR margin (except for the accuracy limit). With the reduced power, the packet error rate may still be within the expected limits to pass the test.

### EXAMPLES

In one example, a transmitter may perform link adaptation, using SNR feedback from the receiver to predict the performance for various link settings and selecting the link settings to be used from the prediction.

In one example, the link setting may be selected. The link setting may be selected for the highest effective throughput. The link setting may be selected low latency. The link setting may be selected for the maximum PHY rate with respect to a target bit error ratio or packet error ratio.

In one example, for the link settings the SNR margin may be calculated with respect to a reference SNR. In one example, the required SNR may be derived from channel capacity, and the SNR gap. In one example, the required SNR may be derived from the capacity of the modulation method (e.g., QAM modulation) that is used, and the SNR gap. In one example, the required SNR may be derived from the dependency between SNR and BER or PER of the FEC and the SNR gap.

In one example, the performance prediction may be based on SNR feedback from the receiver and the SNR gap, which may be maintained at the transmitter. The feedback from data packets, in terms of acknowledgements may be used to update the SNR gap. The feedback from the receiver in terms of SNR margin may be used in addition to update the SNR gap.

In one example, the SNR margin feedback from the receiver may be provided. In one example, the SNR margin and SNR gap per station may be provided. In one example, the SNR margin and SNR gap per station and per spatial stream of the station may be provided. In one example, the SNR margin and SNR gap per station and per carrier or carrier group may be provided. In another example, the SNR margin and SNR gap per station and per carrier or carrier group may be provided.

In one example, power control may be provided. In one example, the predicted SNR margin may be used to reduce or increase the transmit power (e.g., per spatial stream; per carrier or carrier group; or per spatial stream and carrier or carrier group). In another example, the SNR margin feedback from the receiver may be used to increase or decrease the transmit power (e.g., per spatial stream; per carrier or carrier group; or per spatial stream and carrier or carrier group).

In one example, channel aging may be addressed. In one example, the SNR margin feedback may be used to determine the new PHY link settings when the link quality changes due to aging. In another example, the SNR margin feedback may be used to determine the point in time, when a new channel sounding is performed.

In one example, a receiver with SNR margin feedback may be provided. The SNR margin feedback from the receiver may determine the SNR margin and SNR gap: per station; per station and per spatial stream of the station; or per station and per carrier or carrier group.

In one example, the SNR margin feedback to the transmitter may be calculated with respect to a reference SNR. The required SNR may be derived from channel capacity and the SNR gap. The required SNR may be derived from the capacity of the modulation method (e.g., QAM modulation) that is used and the SNR gap. The required SNR may be derived from the dependency between SNR and BER or PER of the FEC and the SNR gap.

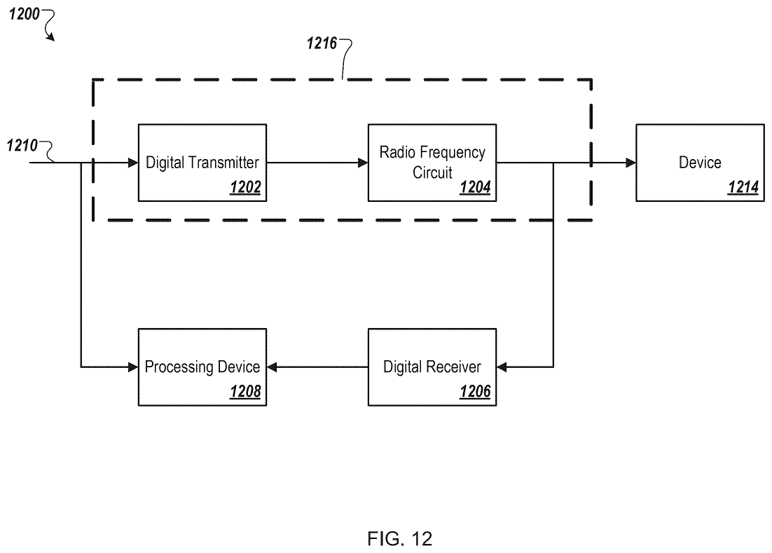

FIG. 12 illustrates a block diagram of an example communication system 1200 configured for WLAN fast link adaptation, in accordance with at least one example described in the present disclosure. The communication system 1200 may include a digital transmitter 1202, a radio frequency circuit 1204, a device 1214, a digital receiver 1206, and a processing device 1208. The digital receiver 1206 and the processing device may be configured to receive a baseband signal via connection 1210. A transceiver 1216 may comprise the digital transmitter 1202 and the radio frequency circuit 1204.

In some examples, the communication system 1200 may include a system of devices that may be configured to communicate with one another via a wired or wireline connection. For example, a wired connection in the communication system 1200 may include one or more Ethernet cables, one or more fiber-optic cables, and/or other similar wired communication mediums. Alternatively, or additionally, the communication system 1200 may include a system of devices that may be configured to communicate via one or more wireless connections. For example, the communication system 1200 may include one or more devices configured to transmit and/or receive radio waves, microwaves, ultrasonic waves, optical waves, electromagnetic induction, and/or similar wireless communications. Alternatively, or additionally, the communication system 1200 may include combinations of wireless and/or wired connections. In these and other examples, the communication system 1200 may include one or more devices that may be configured to obtain a baseband signal, perform one or more operations to the baseband signal to generate a modified baseband signal, and transmit the modified baseband signal, such as to one or more loads.

In some examples, the communication system 1200 may include one or more communication channels that may communicatively couple systems and/or devices included in the communication system 1200. For example, the transceiver 1216 may be communicatively coupled to the device 1214.

In some examples, the transceiver 1216 may be configured to obtain a baseband signal. For example, as described herein, the transceiver 1216 may be configured to generate a baseband signal and/or receive a baseband signal from another device. In some examples, the transceiver 1216 may be configured to transmit the baseband signal. For example, upon obtaining the baseband signal, the transceiver 1216 may be configured to transmit the baseband signal to a separate device, such as the device 1214. Alternatively, or additionally, the transceiver 1216 may be configured to modify, condition, and/or transform the baseband signal in advance of transmitting the baseband signal. For example, the transceiver 1216 may include a quadrature up-converter and/or a digital to analog converter (DAC) that may be configured to modify the baseband signal. Alternatively, or additionally, the transceiver 1216 may include a direct radio frequency (RF) sampling converter that may be configured to modify the baseband signal.

In some examples, the digital transmitter 1202 may be configured to obtain a baseband signal via connection 1210. In some examples, the digital transmitter 1202 may be configured to up-convert the baseband signal. For example, the digital transmitter 1202 may include a quadrature up-converter to apply to the baseband signal. In some examples, the digital transmitter 1202 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 1202.

In some examples, the transceiver 1216 may include one or more subcomponents that may be used in preparing the baseband signal and/or transmitting the baseband signal. For example, the transceiver 1216 may include an RF front end (e.g., in a wireless environment) which may include a power amplifier (PA), a digital transmitter (e.g., 1202), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 1204) of the transceiver 1216 may be synchronized with the resource controller via the S-plane device, which may contribute to high-accuracy timing with respect to a reference clock.

In some examples, the transceiver 1216 may be configured to obtain the baseband signal for transmission. For example, the transceiver 1216 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 1216 may be configured to generate a baseband signal for transmission. In these and other examples, the transceiver 1216 may be configured to transmit the baseband signal to another device, such as the device 1214.

In some examples, the transceiver 1216 may be configured to receive a transmission from the device 1214. For example, the transceiver 1216 may be configured to transmit a baseband signal to the device 1214.

In some examples, the radio frequency circuit 1204 may be configured to transmit the digital signal received from the digital transmitter 1202. In some examples, the radio frequency circuit 1204 may be configured to transmit the digital signal to the device 1214 and/or the digital receiver 1206. In some examples, the digital receiver 1206 may be configured to receive a digital signal from the RF circuit and/or send a digital signal to the processing device 1208.

In some examples, the processing device 1208 may be a standalone device or system, as illustrated. Alternatively, or additionally, the processing device 1208 may be a component of another device and/or system. For example, in some examples, the processing device 1208 may be included in the transceiver 1216. In instances in which the processing device 1208 is a standalone device or system, the processing device 1208 may be configured to communicate with additional devices and/or systems remote from the processing device 1208, such as the transceiver 1216 and/or the device 1214. For example, the processing device 1208 may be configured to send and/or receive transmissions from the transceiver 1216 and/or the device 1214. In some examples, the processing device 1208 may be combined with other elements of the communication system 1200.

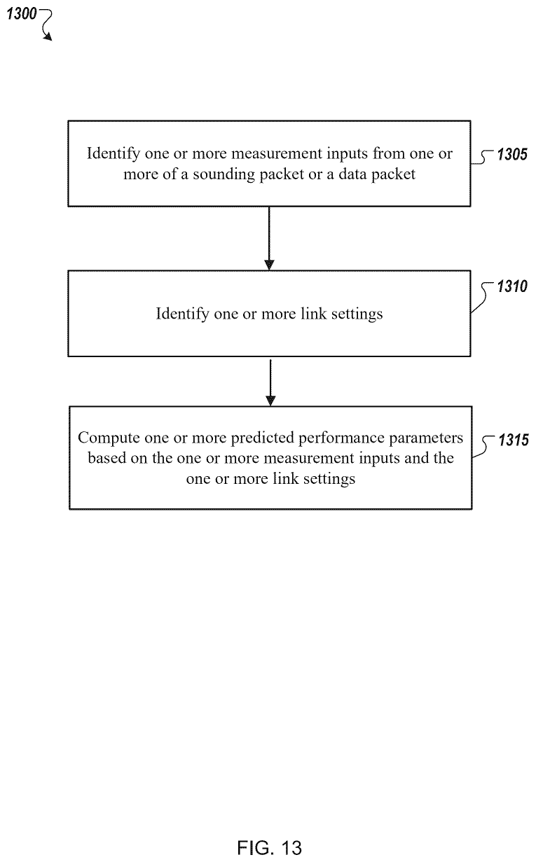

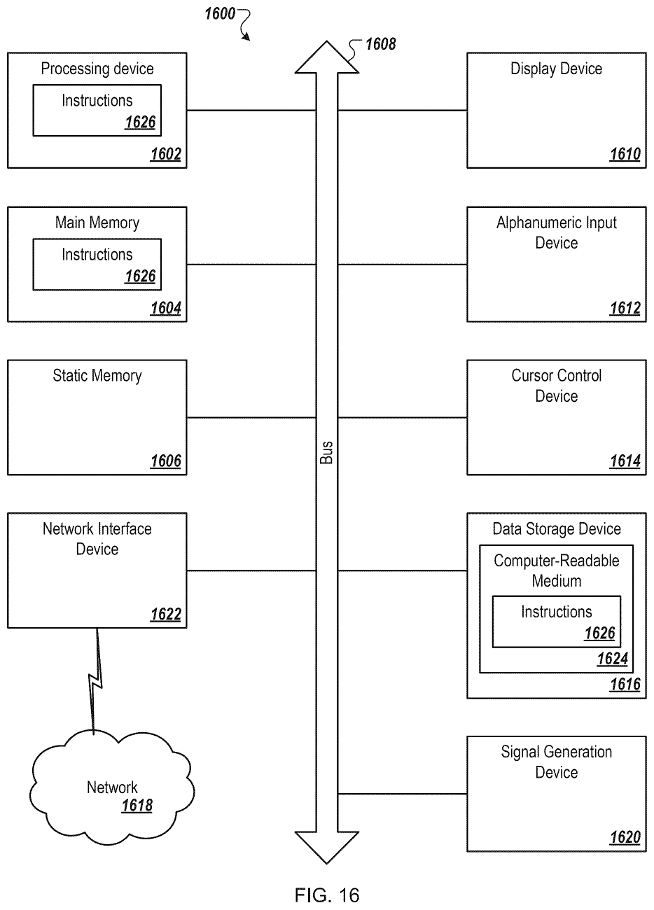

FIG. 13 illustrates a process flow of an example method 1300 of WLAN fast link adaptation, in accordance with at least one example described in the present disclosure. The method 1300 may be arranged in accordance with at least one example described in the present disclosure. The method 1300 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1200 of FIG. 12, or another device, combination of devices, or systems.

The method 1300 may begin at block 1305 where the processing logic may identify, at the AP, one or more measurement inputs from one or more of a sounding packet or a data packet. At block 1310, the processing logic may identify, at the AP, one or more link settings. At block 1315, the processing logic may compute, at the AP, one or more predicted performance parameters based on the one or more measurement inputs and the one or more link settings.

Modifications, additions, or omissions may be made to the method 1300 without departing from the scope of the present disclosure. For example, in some examples, the method 1300 may include any number of other components that may not be explicitly illustrated or described.

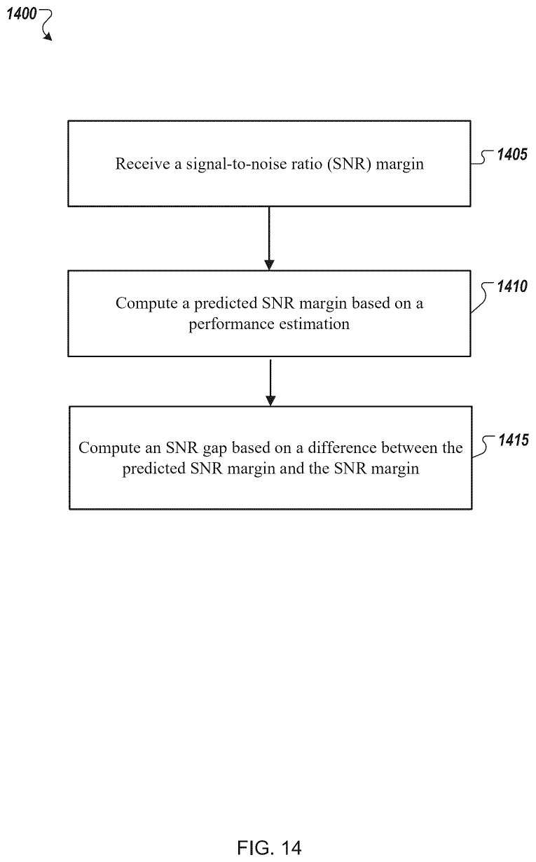

FIG. 14 illustrates a process flow of an example method 1400 of WLAN fast link adaptation, in accordance with at least one example described in the present disclosure. The method 1400 may be arranged in accordance with at least one example described in the present disclosure. The method 1400 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1200 of FIG. 12, or another device, combination of devices, or systems.

The method 1400 may begin at block 1405 where the processing logic may receive, at the AP from a station (STA), a signal-to-noise ratio (SNR) margin. At block 1410, the processing logic may compute, at the AP, a predicted SNR margin based on a performance estimation. At block 1415, the processing logic may compute, at the AP, an SNR gap based on a difference between the predicted SNR margin and the SNR margin.

Modifications, additions, or omissions may be made to the method 1400 without departing from the scope of the present disclosure. For example, in some examples, the method 1400 may include any number of other components that may not be explicitly illustrated or described.

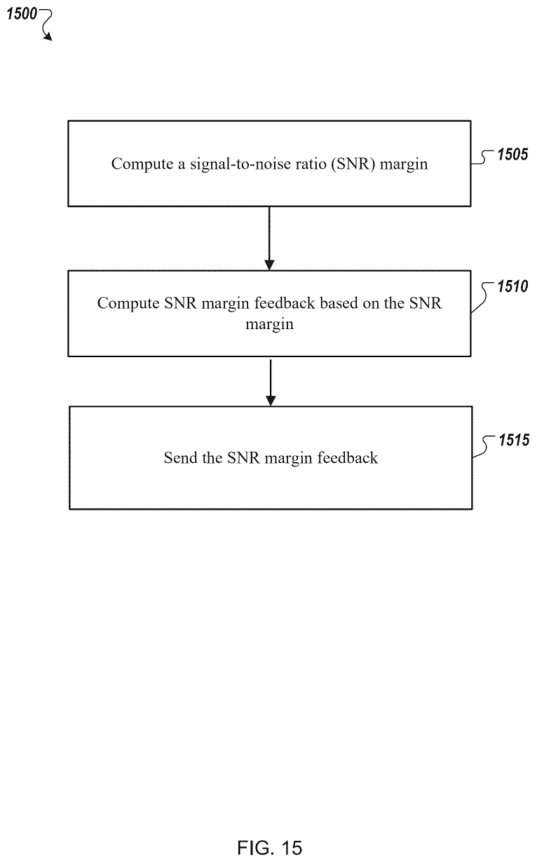

FIG. 15 illustrates a process flow of an example method 1500 of WLAN fast link adaptation, in accordance with at least one example described in the present disclosure. The method 1500 may be arranged in accordance with at least one example described in the present disclosure. The method 1500 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1200 of FIG. 12, or another device, combination of devices, or systems.

The method 1500 may begin at block 1505 where the processing logic may compute, at the STA, a signal-to-noise ratio (SNR) margin. At block 1510, the processing logic may compute, at the STA, SNR margin feedback based on the SNR margin. At block 1515, the processing logic may send, from the STA to an access point (AP), the SNR margin feedback.

Modifications, additions, or omissions may be made to the method 1500 without departing from the scope of the present disclosure. For example, in some examples, the method 1500 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 16 illustrates a diagrammatic representation of a machine in the example form of a computing device 1600 within which a set of instructions, for causing the machine to perform any one or more of the methods discussed herein, may be executed. The computing device 1600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1600 includes a processing device 1602, a main memory 1604 (e.g., read-only memory (ROM), flash memory, dynamic random access memory (DRAM) such as synchronous DRAM (SDRAM)), a static memory 1606 (e.g., flash memory, static random access memory (SRAM)) and a data storage device 1616, which communicate with each other via a bus 1608.

Processing device 1602 represents one or more general-purpose processing devices such as a microprocessor, central processing unit, or the like. More particularly, the processing device 1602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1602 may also include one or more special-purpose processing devices such as an application specific integrated circuit (ASIC), a field programmable gate array (FPGA), a digital signal processor (DSP), network processor, or the like. The processing device 1602 is configured to execute instructions 1626 for performing the operations and steps discussed herein.

The computing device 1600 may further include a network interface device 1622 which may communicate with a network 1618. The computing device 1600 also may include a display device 1610 (e.g., a liquid crystal display (LCD) or a cathode ray tube (CRT)), an alphanumeric input device 1612 (e.g., a keyboard), a cursor control device 1614 (e.g., a mouse) and a signal generation device 1620 (e.g., a speaker). In at least one example, the display device 1610, the alphanumeric input device 1612, and the cursor control device 1614 may be combined into a single component or device (e.g., an LCD touch screen).

The data storage device 1616 may include a computer-readable storage medium 1624 on which is stored one or more sets of instructions 1626 embodying any one or more of the methods or functions described herein. The instructions 1626 may also reside, completely or at least partially, within the main memory 1604 and/or within the processing device 1602 during execution thereof by the computing device 1600, the main memory 1604 and the processing device 1602 also constituting computer-readable media. The instructions may further be transmitted or received over a network 1618 via the network interface device 1622.

While the computer-readable storage medium 1624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP) comprising:
a processing device operable to:
identify, at the AP, one or more measurement inputs from one or more of a sounding packet or a data packet;
identify, at the AP, one or more link settings; and
compute, at the AP, one or more predicted performance parameters based on the one or more measurement inputs and the one or more link settings.

2. The AP of claim 1, wherein the processing device is further operable to:
compute, at the AP, the one or more predicted performance parameters comprising one or more of predicted signal-to-noise ratio (SNR) or a predicted goodput.

3. The AP of claim 2, wherein the processing device is further operable to:
compute, at the AP, the predicted SNR based on an SNR received from a sounding packet.

4. The AP of claim 2, wherein the processing device is further operable to:
compute, at the AP, one or more of a bit error rate, packet error rate, or the goodput based on the predicted SNR and an SNR gap.

5. The AP of claim 1, wherein the one or more measurement inputs include one or more of: a signal-to-noise ratio (SNR) per spatial stream and carrier group, a compressed channel estimation feedback, a packet error rate, an SNR margin per spatial stream, or an SNR margin per spatial stream and carrier group.

6. The AP of claim 1, wherein the one or more link settings include one or more of modulation and coding scheme (MCS), number of spatial streams, transmit power, bandwidth, a set of simultaneously served stations (STAs), or an association of STAs to APs.

7. The AP of claim 1, wherein the processing device is further operable to:
send, from the AP to a STA, a sounding packet; and
receive, at the AP from the STA, a feedback report.

8. The AP of claim 1, wherein the processing device is further operable to:
initialize, at the AP, a signal-to-noise ratio (SNR) gap;
receive, at the AP, an SNR margin; and
update, at the AP, the SNR gap based on the SNR margin.

9. An access point (AP) comprising:
a processing device operable to:
receive, at the AP from a station (STA), a signal-to-noise ratio (SNR) margin;
compute, at the AP, a predicted SNR margin based on a performance estimation; and
compute, at the AP, an SNR gap based on a difference between the predicted SNR margin and the SNR margin.

10. The access point of claim 9, wherein the processing device is further operable to:
compute, at the AP, the predicted SNR margin based on a difference between an actual SNR and a required SNR.

11. The access point of claim 10, wherein the processing device is further operable to:
compute, at the AP, the required SNR using one or more of a Gaussian capacity, a quadrature amplitude modulation (QAM) capacity, or a forward error correction (FEC) model.

12. The access point of claim 9, wherein the processing device is further operable to:
compute, at the AP, a packet error rate; and
compute, at the AP, an SNR gap update based on the packet error rate.

13. The access point of claim 9, wherein the processing device is further operable to:
adjust, at the AP, a transmit power based on the predicted SNR margin.

14. The access point of claim 9, wherein the processing device is further operable to:
adjust, at the AP, a transmit power based on SNR margin feedback.

15. The access point of claim 9, wherein the processing device is further operable to:
compute, at the AP, updated link settings based on SNR margin feedback.

16. The access point of claim 9, wherein the processing device is further operable to:
perform, at the AP, updated channel sounding based on SNR margin feedback.

17. A station (STA) comprising:
a processing device operable to:
compute, at the STA, an signal-to-noise ratio (SNR) margin;
compute, at the STA, SNR margin feedback based on the SNR margin; and
send, from the STA to an access point (AP), the SNR margin feedback.

18. The STA of claim 17, wherein the processing device is further operable to:
compute, at the STA, the SNR margin based on an SNR.

19. The STA of claim 17, wherein the processing device is further operable to:
compute, at the STA, the SNR margin based on a bit error rate (BER).

20. The STA of claim 17, wherein the processing device is further operable to:
compute, at the STA, the SNR margin based on log likelihood ratios (LLRs).
